(19) United States
(12) Patent Application Publication
(10) Pub. No.: US 2006/0149614 A1
(43) Pub. Date: Jul. 6, 2006

(54) Dynamic brand evaluation information processing apparatus and method

(76) Inventors: Hiroe Suzuki, Tokyo (JP); Shigeo Okazaki, Tokyo (JP); Hiroshi Mochizuki, Tokyo (JP); Shigeru Ofurutono, Kawasaki-shi (JP); Keisuke Konishi, Tokyo (JP); Yukiyasu Kubota, Tokyo (JP); Takuya Okumura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/538,881

(22) PCT Filed: Dec. 16, 2002
(86) PCT No.: PCT/JP02/13125

§ 371 Date: Jan. 30, 2006

(51) Int. Cl. G06F 17/30

(52) U.S. Cl. 705/10

(57) ABSTRACT

A model format storing unit stores a model format representing a cyclic process of brand knowledge creation. Arrangement of dynamic evaluation parameters obtained by factor analysis of several indices for brand-creation process evaluation is set in the model format. A target brand parameter acquiring unit acquires dynamic evaluation parameters for a target brand. A model creating unit arranges the dynamic evaluation parameters for the target brand in accordance with the setting of the model format. In this way, a model of the target brand is created and outputted. The dynamic evaluation parameters are six parameters of contact, cognition, interaction, coherence, characterization, and alignment. With this model, circulation of brand knowledge creation is represented with appropriate parameters.

### TECHNICAL FIELD

The present invention relates to a brand-creation process evaluation system, and in particular to a system that provides a brand-creation process evaluation model about a target brand to thereby provide information useful for brand-building.

### BACKGROUND ART

As it is well known, brands are important assets for companies and often have great value. Obviously, it is important for companies to evaluate brands and build strong brands.

Therefore, conventionally, a computer has been used to provide the results of brand analysis as information of brand evaluation. For example, several evaluation parameters such as differentiation, relevance, esteem, and knowledge are presented in a graph format.

However, in general, the evaluation information, conventionally provided, is information representing the present brand value as a result of brand-building, that is, static information representing the present state of the brand.

On the other hand, if evaluation information representing the dynamic state of a brand can be provided, such information is considered to be extremely useful for examining how to build a strong brand.

In this regard, “Branding Capabilities in Creating Knowledge” (Satoshi Akutsu, Ikujiro Nonaka, Diamond Harvard Business Review, August 2001, 173 to 186 pages, Kabushiki Kaisha Diamond-sha, Japan) proposes a model that represents a dynamic process of brand-building. A model for brand-building is represented by a process of brand knowledge creation. In this process, explicit knowledge and tacit knowledge with respect to a brand follow a cyclic path. Explicit knowledge is knowledge that is represented explicitly through language and text. Tacit knowledge is subjective knowledge that is difficult to represent in language and text. For example, tacit knowledge includes a thought, a point of view, know-how, a schema, and a mental model.

In addition, “MARKETING RESEARCH” (David A. Aaker, et al., Seventh Edition, John Wiley & Sons, Inc.) and “The Knowledge-Creating Company” (Nonaka, et al., May 1995, Oxford University Press) also disclose a knowledge creation theory, which is related to the invention.

The inventors have examined a practical brand-creation process evaluation model on the basis of the knowledge creation theory of the references described above. As a result, the inventors have reached the system of the invention for providing information on a brand-creation process evaluation model.

### DISCLOSURE OF THE INVENTION

With the objective of creating a useful brand-creation process evaluation model, as explained below, the inventors have combined factor analysis, a statistical method, with the brand knowledge creation theory.

When a brand-building model is represented as a cyclic process of brand knowledge creation, the problem of what kind of evaluation parameters should be analyzed in this cyclic process arises. The evaluation parameters are required to represent the cyclic process correctly and to be useful for examining how a brand should be built. In order to meet such an objective, it is important to use evaluation parameters that make it easy to grasp the state of the cyclic process.

In order to find such evaluation parameters, the inventors focused on factor analysis. Factor analysis integrates several variables into a group of variables having high similarity. Thus, under the assumption that brand knowledge is created through a cyclic process, several indices for brand-creation process evaluation are prepared. Groups of indices are obtained by factor analysis of these indices. Dynamic evaluation parameters corresponding to these groups of indices are defined. The dynamic evaluation parameters obtained in this way meet the requirements described above.

Information processing of the invention uses a model format representing the cyclic process of brand creation. This model format sets the arrangement of the dynamic evaluation parameters that are obtained by the factor analysis described above. Information processing in the invention acquires specific values of the dynamic evaluation parameters with respect to the target brand. The acquired dynamic evaluation parameters are arranged in set positions in the model format. In this way, the brand-creation process evaluation model for the target brand is created and presented. The presented model indicates what state of the cyclic process of brand-building the target brand currently occupies. This model clearly defines the dynamic evaluation parameters that should be focused to facilitate the process of brand knowledge creation for the target brand. Therefore, it is possible to use this model advantageously for enhancing the creation process for the target brand, that is, for strengthening the brand.

One aspect of the invention is a brand-creation process evaluation system. This system includes four means. First, the system includes model format storing means that store information on a model format representing a cyclic process of brand knowledge creation in which arrangement of dynamic evaluation parameters, which correspond to several groups of indices obtained by factor analysis of several indices for dynamic evaluation of a brand, respectively, are set. Second, the system includes target brand parameter acquiring means that acquires dynamic evaluation parameters for evaluation of a target brand. Third, the system includes model creating means that create a brand-creation process evaluation model of the target brand by arranging the dynamic evaluation parameters for the target brand, which are acquired by the target brand parameter acquiring means, in positions set in the model format with reference to information of the model format. Fourth, the system includes output means that outputs information on the brand-creation process evaluation model created by the model creating means. For this invention, system can provide the advantageous brand-creation process the evaluation model.

Preferably, the dynamic evaluation parameters include a contact parameter representing a degree of “contact” with a brand, an cognition parameter representing a degree of “cognition” which is tacit knowledge with respect to the brand, an interaction parameter representing a degree of “interaction” which is explicit knowledge with respect to the brand, and a coherence parameter representing a degree of “coherence” which is another tacit knowledge with respect to the brand. Arrangement of these parameters is set on a cyclic path in the order described above in the model format.

The model indicates importance of circulation including “cognition” and “coherence”. In particular, the model indicates importance of dynamic circulation in which the process does not stay in “coherence” and “cognition” occurs repeatedly. If an evaluation value of a target brand is applied to such a model, it is seen whether the dynamic circulation process functions properly in the target brand. Therefore, according to the invention, a material for judgment, which is extremely useful for facilitating building of the target brand, is obtained.

Preferably, the dynamic evaluation parameters further include a characterization parameter representing “characterization”, which serves as an opportunity for shift from “contact” with a brand to “cognition” of the brand, and an alignment parameter representing “alignment” that appears when “interaction” of the brand shifts to “coherence”. The model format sets arrangement of the characterization parameter in association with a path from the contact parameter to the cognition parameter and sets arrangement of the alignment parameter in association with a path from the interaction parameter to the coherence parameter.

The model described above has the characterization parameter and the alignment parameter, which properly represent the magnitude of an action for facilitating circulation of the brand knowledge creation process, in an appropriate arrangement. Therefore, the model is extremely useful in facilitating brand-building.

The invention is not limited to the aspects of the brand-creation process evaluation system described above. Other aspects of the invention include a brand-creation process evaluation method, a program that causes a computer to execute such a method, and a medium having such a program recorded therein.

### BRIEF DESCRIPTION OF THE DRAWINGS

FIG. 1 is a block diagram showing the brand-creation process evaluation system in the embodiment of the invention.

FIG. 2 is a diagram showing the brand-creation process evaluation model treated in the system in FIG. 1.

FIG. 3 is a diagram showing the result of factor analysis for forming the model in FIG. 2.

FIG. 4 is a diagram showing the cyclic action of the brand-creation process evaluation model in FIG. 2.

FIG. 5 is a diagram showing the list of question items that is used for obtaining dynamic evaluation parameters of the brand-creation process evaluation model.

FIG. 6 is another diagram showing the list of question items that is used for obtaining dynamic evaluation parameters of the brand-creation process evaluation model.

FIG. 7 is a diagram showing options of target breakdown for subjects in brand evaluation.

FIG. 8 is a diagram showing an example of the brand-creation process evaluation model presented by the brand-creation process evaluation system in FIG. 1.

FIG. 9 is a flowchart showing the operation of the system in FIG. 1.

### THE PREFERRED EMBODIMENT OF THE INVENTION

An embodiment of the invention will be hereinafter explained with reference to the accompanying drawings.

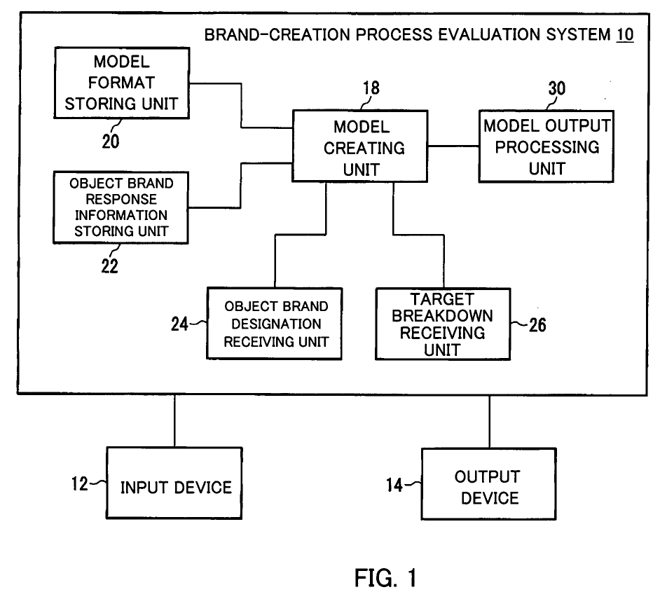

FIG. 1 shows the brand-creation process evaluation system in this embodiment. The brand-creation process evaluation system 10 in FIG. 1 is constituted by a computer. A general-purpose computer or a dedicated computer may be used as the brand-creation process evaluation system 10. The brand-creation process evaluation system 10 has a basic configuration of a computer such as a CPU, a RAM, and a ROM. The brand-creation process evaluation system 10 executes a program for realizing processing of the brand-creation process evaluation model of the invention. This program is installed in the computer.

As shown in FIG. 1, an input device 12 and an output device 14 are connected to the brand-creation process evaluation system 10. The input device 12 includes a keyboard and a pointing device. The output device 14 includes a display and a printer.

The brand-creation process evaluation system 10 in FIG. 1 is an independent computer. However, functions of the brand-creation process evaluation system 10 may be distributed to several computers.

The brand-creation process evaluation system 10 in FIG. 1 may be connected to another computer through communication using a network or the like. In this case, a communication function of the brand-creation process evaluation system 10 can function as the input device 12 and the output device 14.

The information processing apparatus 10 may be connected to other computers via the Internet. In this case, a WWW server can function as the input device 12 and the output device 14.

Moreover, when data necessary for brand-creation process evaluation is read from a recording medium, a reading function can function as the input device 12. When a result of the evaluation is written in the recording medium, a writing function can function as the output device 14.

As shown in FIG. 1, in order to realize a function of brand-creation process evaluation, the brand-creation process evaluation system 10 has a model format storing unit 20, a target brand response information storing unit 22, a target brand designation receiving unit 24, a target breakdown receiving unit 26, a dynamic evaluation parameter calculating unit 28, a model creating unit 30, and a model output processing unit 32.

Among these elements, the model format storing unit 20 stores information on a model format. The model format corresponds to a characteristic brand-creation process evaluation model in this embodiment.

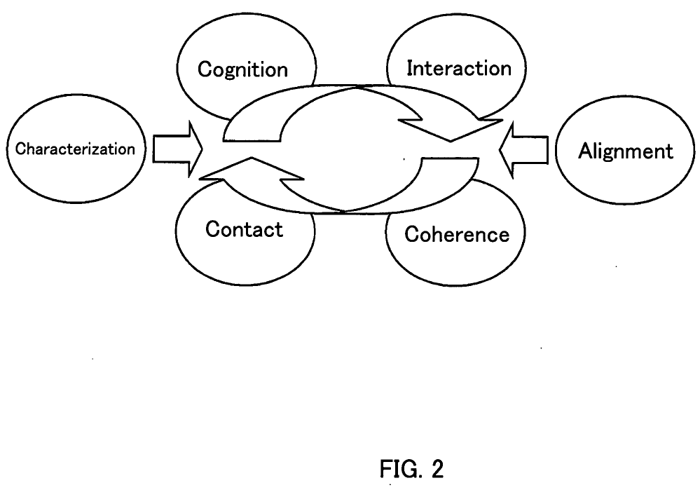

FIG. 2 shows the brand-creation process evaluation model in this embodiment. This model represents a cyclic process of brand knowledge creation to thereby visualize a flow of brand-building. Six dynamic evaluation parameters are arranged in the cyclic process. The arrangement of these parameters is stored in the model format storing unit 20 as a model format.

The model in FIG. 2 is created by combining a factor analysis technique, a statistical method, with the brand knowledge creation theory.

According to the brand knowledge creation theory, a brand-building model is represented by the cyclic process of brand knowledge creation. However, when attempting to create a practical model, there is a problem of what kind of evaluation parameters should be arranged in the cyclic process. The evaluation parameters are required to represent the cyclic process correctly and to be useful for examining how a brand should be built. In order to attain such an object, evaluation parameters, which make it easy to grasp a state of the circulation process, are effective.

Thus, the inventors focused to factor analysis in order to obtain appropriate evaluation parameters. Factor analysis is a statistical analysis technique that can integrate several variables into a group of variables having high similarity.

As a specific example, on the premise that brand knowledge creation follows a cyclic process, twenty indices considered to be appropriate for dynamic evaluation are set. The twenty indices are as listed below.
(1) Many opportunities index
(2) More insightful experience index
(3) Ample brand information index
(4) Corporate philosophy index
(5) Personality understood index
(6) Clear brand features index
(7) Clear marketing objective index
(8) Different impression index
(9) Appealing index
(10) New imagery index
(11) New-found interest index
(12) Social interaction index
(13) Reputation awareness index
(14) More people interested index
(15) Specific mood conveyed index
(16) Autonomous value index
(17) Purchase-decision criteria index
(18) Uniqueness perceived index
(19) Depth perceived index
(20) Coherence perceived index

Twenty questions corresponding to these indices are prepared. The questions are created capable of obtaining answers which show the degree of the respective indices. These twenty questions are given to consumers and responses to the questions are acquired. Questions are provided for each of the plural brands and responses to the questions are obtained.

Factor analysis is applied to investigation results obtained in this way. Factor analysis is an analysis method of extracting common factors (elements) lying behind variables on the basis of correlation among several variables. As described already, factor analysis can integrate several variables into a group of variables having high similarity. Typically, peculiar values “eigenvalues” of the several factors are obtained from the responses to the several questions. Then, factors having large peculiar values are adopted. Factor analysis is a well-known technique and is described in, for example, “Marketing Basics” (Japan Marketing Association, Second Edition, March 2001, 93 to 119 pages, in particular, 112 to 115 pages).

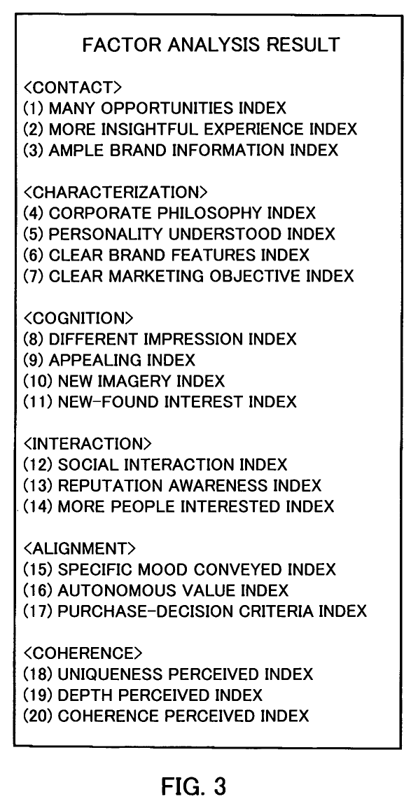

FIG. 3 shows results of factor analysis. As shown in the figure, the twenty indices are classified into six groups of indices. Dynamic index parameters are set for the respective groups of indices. The respective dynamic index parameters have names symbolizing the respective groups of indices. As shown in the figure, the dynamic index parameters are “contact”, “characterization”, “cognition”, “interaction”, “alignment”, and “coherence”.

These six parameters are arranged on a model based on the brand knowledge creation theory. According to the brand knowledge creation theory, as described above, brand knowledge creation forms a cyclic process. The respective parameters are arranged in appropriate positions on this process. As a result, the model in FIG. 2 is obtained.

The model in FIG. 2 is explained as follows as a whole. With reference to FIG. 2, a process, in which brand knowledge in customers and consumers is actually formed, will be considered on the basis of an indication from the brand knowledge creation theory. First, it is needless to mention that “contact” in a broad sense concerning a brand is a starting point of the process no matter if the contact is actual use of goods or services or contact with information. An original form of brand knowledge serving as tacit knowledge is created by “contact”. However, “contact” not left in memory or mind does not change to new knowledge having continuity. “Contact” requires some “cognition” such that knowledge is created from the “contact”. What causes “cognition” is “novelty” of a meaning felt in contact in many cases. However, as a premise of the cognition, it is required that characteristics of goods and services are clear for customers and consumers and a key of brand value is recognized through specific values of the goods and services.

Recognition itself of “novelty” of a brand is an internal matter of an individual person. There are opportunities in which the brand comes up in talks with other people or a similar view is introduced in media or the like. As a result, when an increase in interest in the brand is recognized, brand knowledge becomes common knowledge beyond the personal recognition through a filter of the society and other people. This means that tacit knowledge inside the individual is converted into explicit knowledge that can be shared in a group and in society. A so-called good brand has acquired a position as “social existence” in many cases. A motive power for acquiring the position as “social existence” resides in socialization of knowledge of the brand.

The brand knowledge has a characteristic that, at the beginning when a brand is introduced into the world, adheres to characteristics of goods to which the brand is attached. A brand, which has expanded smoothly in a brand-creation process, gradually “transcends” from the specific characteristics to assume an autonomous value. Then, a “brand world” as a set of knowledge having a consistency and coherence as the brand as a whole is established.

Such a brand-building process circulates as the brand always provides a new value exceeding expectation of customer and consumers. By visualizing dynamism of brand-building from a process theory, it becomes possible to overcome the limitation that the conventional “brand equity theory” can only evaluate brand assets, which were accumulated in the past, statically.

Next, the meanings of the respective parameters of the model in FIG. 2 are explained as follows. “Contact”

“Contact” is a recognition score about plentifulness of experiences such as contact with and use of information concerning goods and services of a brand. “Contact” serves as a key to “realization and update of brand knowledge”.

“Characterization”

“Characterization” is a score of recognition that characteristics and nature of a brand, a corporate idea included in the brand, and the like are made clear. “Characterization” serves as an opportunity for creating new cognition.

“Cognition”

“Cognition” is a score of recognition that customers and consumers feel unprecedented element and image in a brand and interest in the brand is aroused. The level of the score of “cognition” serves as a motive force for updating brand knowledge.

“Interaction”

“Interaction” is a score of recognition that customers and consumers talked about a brand with others and feel an increase in a social interest in the brand. “Interaction” is an item on which “social existence” is reflected.

“Alignment”

“Alignment” is a score indicating whether customers and consumers feel that knowledge concerning a brand itself has an abstracted autonomous value exceeding knowledge concerning individual goods and services.

“Coherence”

“Coherence” is a score about whether customers and consumers feel an independent view of world and coherence from a brand. “Coherence” indicates a degree of establishment of value of the brand itself and a degree of consistency between brand value and a sense of value of subjects themselves and, at the same time, is an index indicating the risk of brand rigidness.

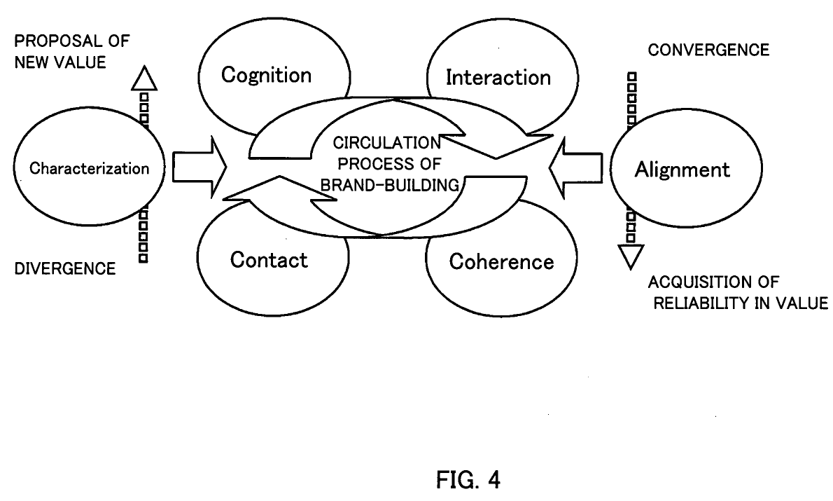

In FIG. 4, an explanation of cyclic action is added to the model described above. As shown in FIG. 4, “contact” is contact with and experience of a brand, “cognition” is a new development obtained from the brand, “interaction” is an increase in social interest in the brand, and “coherence” is a deep reliance on the brand. Further, “characterization” is characterization of brand characteristics and “alignment” is creation of an autonomous value of the brand.

“Contact”, “cognition”, “interaction”, “and “coherence” circulate in this order, as shown in the figure. “Characterization” acts between “contact” and “cognition” to facilitate the circulation. “Alignment” acts between “interaction” and “coherence”.

In the circulation, it may be considered that “cognition” and “coherence” belong to tacit knowledge and “interaction” belongs to explicit knowledge. Therefore, according to the model shown in the figure, the tacit knowledge and the explicit knowledge circulate as indicated by the brand knowledge creation theory.

When the circulation of this model proceeds appropriately, a strong brand is built. The sound state of a brand, which is already strong, is maintained. For such circulation, a process to new cognition is required after coherence is obtained. In other words, unless new cognition occurs repeatedly, it is difficult to strengthen a brand.

The circulation of this model includes two vectors. One of the vectors is realization of brand knowledge. This is related to “characterization” and facilitates cognition according to a proposal of a new value. The other is “integration and autonomy of brand knowledge”. This is related to “alignment” and leads to acquisition of reliability in brand value. This model serves as a material for judgment on which vector should be given priority. Consequently, this model serves as a useful material for judgment on what should be done to establish a strong brand.

Referring back to FIG. 1, the structure of the brand-creation process evaluation system 10 in this embodiment for treating the model will be explained. The model in FIG. 2 represents a concept of a brand-building process that is obtained on the basis of analysis of plural brands. The brand-creation process evaluation system 10 in FIG. 1 finds a state in which this brand-building process is placed in a specific brand, which is an object of evaluation, and presents the state.

In FIG. 1, as already described, the model format storing unit 20 stores the model format. The model format represents a cyclic process of brand knowledge creation. Arrangement of the dynamic evaluation parameters shown in FIG. 2 is set in the model format. The model format is inputted into the brand-creation process evaluation system 10 in advance and stored therein.

The target brand response information storing unit 22 stores basic information for calculating the value of a dynamic evaluation parameter for a target brand. This basic information is obtained as described below.

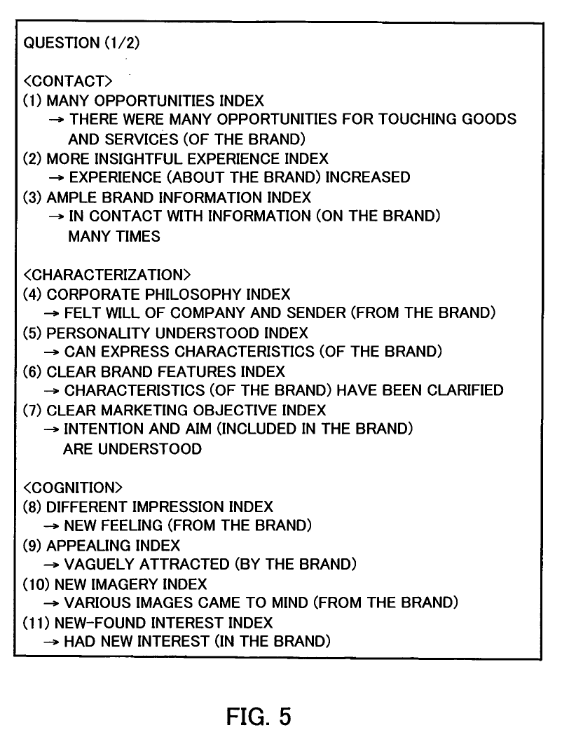

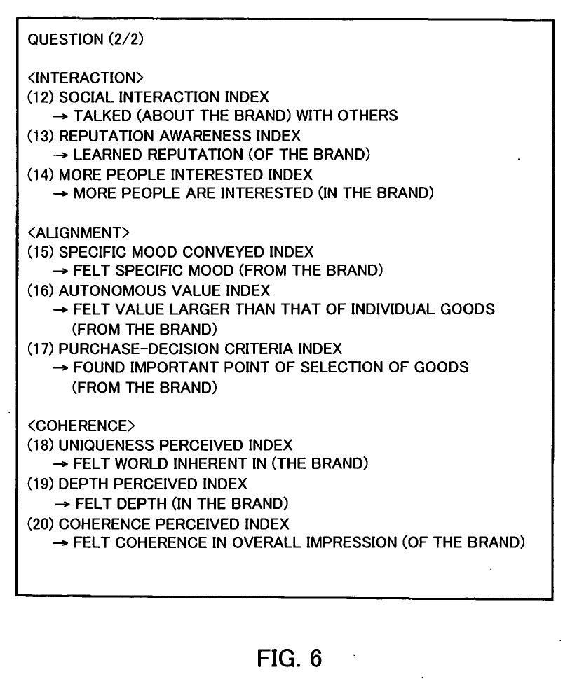

Referring to FIGS. 5 and 6, in this embodiment, twenty questions are prepared. As shown in the figures, these twenty questions correspond to twenty indices used for creating the format of a dynamic evaluation model. These twenty questions and several brands for evaluation are presented to respondents and responses are obtained as YES or NO. The respondents are customers and consumers. There are several respondents, and it is better that a larger number of respondents are present. Response information obtained in this way is used as basic information for finding dynamic evaluation parameters.

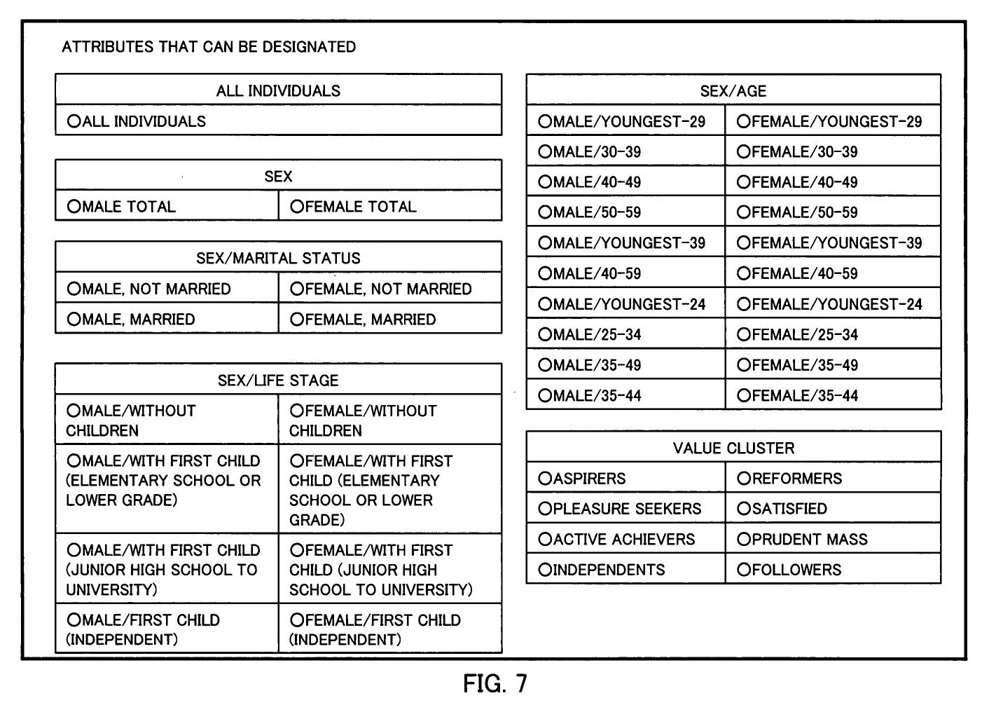

Note that, as shown in FIG. 7, in this embodiment, attribute information of the respondents is taken into account. In other words, responses of the respective respondents are stored together with attributes of the respondents. Therefore, in the following processing, it is possible to process only information on respondents corresponding to a desired attribute. FIG. 7 shows selectable attributes. Although not shown in FIG. 7, in the system in this embodiment, it is also possible to designate an occupation as attribute information.

As described above, the twenty questions shown in FIGS. 5 and 6 are associated with twenty indices that are objects of factor analysis in the step of creating a dynamic model. Originally, in the step of factor analysis, twenty questions substantially the same as those in FIGS. 5 and 6 are used to obtain data of the twenty indices that are the objects of the factor analysis. The twenty questions at the factor analysis step are adjusted taking into account the results of the factor analysis. Thus, the twenty questions shown in FIGS. 5 and 6 are obtained.

Referring back to FIG. 1, the object brand response information storing unit 22 stores information on responses to the questions in FIGS. 5 and 6. Response information of the plural respondents is inputted from the input device 12 and stored in the object brand response information storing unit 22 in a database format.

When the object brand response information storing unit 22 stores information on plural brands, the object brand designation receiving unit 24 receives designation of a brand that becomes an object of model creation. This designation is inputted from the input device 12 by an operator.

The target breakdown receiving unit 26 receives designation of attributes. This designation is also inputted from the input device 12 by the operator. As already described, attributes, which can be designated, are illustrated in FIG. 7. A screen indicating options in FIG. 7 is displayed in the output device 14. An attribute is selected by the operator using the input device 12 and this selection is received by the target breakdown receiving unit 26 as designation of the attribute.

The dynamic evaluation parameter calculating unit 28 is a form of a target brand parameter acquiring unit of the invention and is also a form of a unit that acquires a contact parameter, a cognition parameter, an interaction parameter, a coherence parameter, a characterization parameter, and an alignment parameter of the invention.

The dynamic evaluation parameter calculating unit 28 reads out response information of the target brand from the target brand response information storing unit 22. At this point, response information of the brand designated by the target brand designation receiving unit 24 is read. In addition, a response of a subject corresponding to the attribute designated by the target breakdown receiving unit 26 is read.

Then, the dynamic evaluation parameter calculating unit 28 calculates values of the dynamic evaluation parameters from the read-out response information.

Referring to FIGS. 5 and 6, the respective dynamic evaluation parameters correspond to several questions. The dynamic evaluation parameters are a ratio of the number of respondents who respond to a corresponding question with YES (YES respondents) to the total number of subjects (displayed in %). The YES respondents are people who responded to at least one of the corresponding questions. The number of subjects and the number of YES respondents are calculated from the response information and the number of YES respondents is divided by the number of subjects, whereby values of the parameters are calculated. Such processing may be regarded as “or alignment” of “YES” responses concerning the questions forming the respective parameters.

A formula of a dynamic evaluation parameter is represented as follows.
Dynamic evaluation parameter=(the number of YES respondents/the number of subjects)×100(%)

Here, the number of subjects is the number of respondents corresponding to a designated attribute.

The number of YES respondents is the number of people who responded YES to at least one of several questions related by the dynamic evaluation parameters among the subjects.

For example, as shown in the figure, the contact parameter corresponds to three questions (1) to (3). The YES respondents are those who responded to at least one of questions (1) to (3) with YES. A ratio of the number of YES respondents with respect to the number of subjects is the value of the contact parameter.

The dynamic evaluation parameter calculating unit 28 calculates the contact parameter, the cognition parameter, the interaction parameter, the coherence parameter, the characterization parameter, and the alignment parameter according to the process described above.

Note that, in this embodiment, an algorithm of the parameter calculation may be modified. The definition of the YES respondents may be changed. For example, the YES respondents may be those who responded to two or more questions with YES.

The model creating unit 30 creates a brand-creation process evaluation model of a target brand using the dynamic evaluation parameters calculated by the dynamic evaluation parameter calculating unit 28. Here, the model creating unit 30 refers to the model format stored in the model format storing unit 20. As explained already, the model format represents the circulation process of brand knowledge creation and, in particular, sets arrangement of the respective dynamic evaluation parameters. In accordance with this setting, the model creating unit 30 arranges the respective dynamic evaluation parameters in positions set in the model format. Consequently, a brand-creation process evaluation model of the target brand is created.

The model output processing unit 32 functions as an output unit of the invention and uses the output device 14 to output the brand-creation process evaluation model created by the model creating unit 30. In this embodiment, the output device 14 includes a display and a printer. Therefore, the brand-creation process evaluation model is displayed on the display or printed on the printer.

Note that, as already explained, the brand-creation process evaluation system 10 in this embodiment may be connected to a network such as the Internet. The brand-creation process evaluation model may be outputted to the network using a communication function of the network.

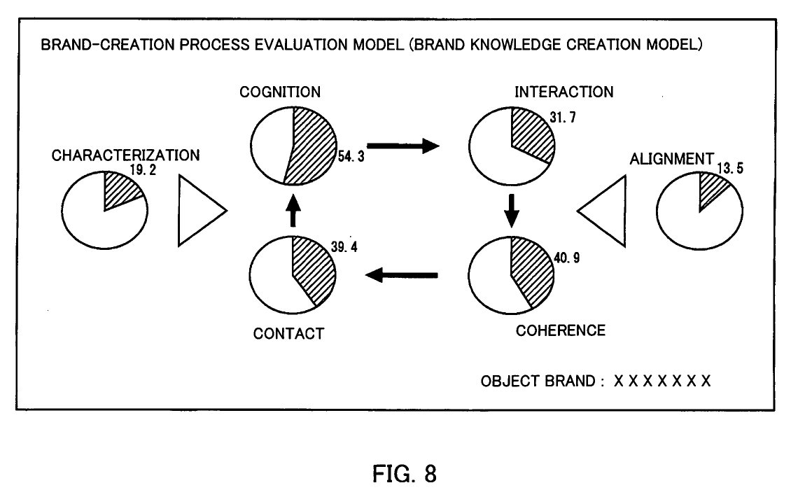

FIG. 8 illustrates a brand-creation process evaluation model for a target brand. AS shown in the figure, six dynamic evaluation parameters are attached to positions corresponding to the six characteristic items symbolizing the cyclic process in the brand-creation process evaluation model in FIG. 2. Values (%) of the respective parameters are represented as pie charts such that the values are easily grasped visually.

In the brand-creation process evaluation model in FIG. 8, when the values of the dynamic evaluation parameters are balanced well, that is, when values of the dynamic evaluation parameters on the cyclic path are relatively close to one another, the cyclic process of brand knowledge creation is considered to be in an appropriate state. When the balance is well or satisfactory and the values of the parameters are relatively large, it can be said that a strong brand is built and maintained.

Conversely, when the balance of the dynamic evaluation parameters is bad, circulation of the process of brand knowledge creation tends to be hindered. Therefore, it may be or is likely that the brand-building process is not in an appropriate state. In this case, even if the values of the parameters are large as a whole, since the circulation is hindered, it may be or is likely that development of the brand is also hindered. Thus, measures for improving the balance are required to be examined for building a strong brand.

For example, when a value of the cognition parameter is relatively low, it is considered preferable to apply a measure for characterization. Consequently, development from contact to cognition is facilitated and the cognition parameter increases to make the circulation state satisfactory. Such a measure is, for example, advertisements on newspapers and magazines, advertisement in traffic facilities, and advertisement on networks. With such a measure, a new value is proposed, brand characteristics are clarified, and a degree of cognition increases.

For example, when a value of the coherence parameter is relatively low, it is considered preferable to apply a measure for facilitating alignment. Consequently, development from interaction to coherence is facilitated and the coherence parameter increases to make the circulation state satisfactory. Such a measure is, for example, television advertisements and events. With such a measure, reliability in a value is acquired, an autonomous value of the brand is created, and the degree of coherence increases.

It is also possible to use the model in FIG. 8 for comparison of a brand of a company with a brand of a competitor. Brand-creation process evaluation models of the own company and the competitor are created and patterns of both the models are compared. When a value of a certain parameter is smaller than a value of the same parameter of the competitor, a measure for increasing the parameter may be effective for strengthening the brand of the own company. Taking this point into account, it is judged from the model which vector of “realization of brand knowledge” (characterization) and “integration and autonomy of brand knowledge” (alignment) should be given priority. In this way, it is also possible to use this model as a material for judgment of strategy examination according to comparison of brands between companies.

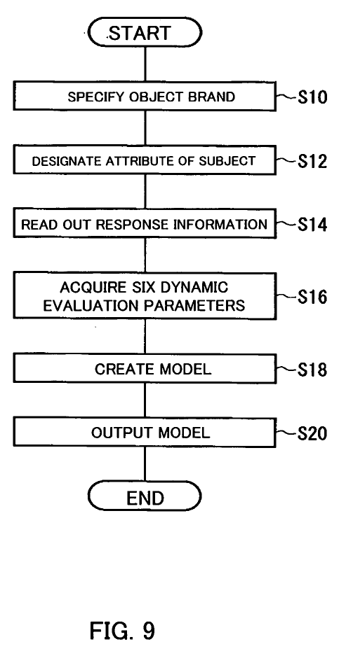

FIG. 9 is a flowchart showing an operation of the brand-creation process evaluation system 10 in FIG. 1. As shown in the figure, the brand-creation process evaluation system 10 designates a target brand (S10) and designates an attribute of a subject (S12). Then, the brand-creation process evaluation system 10 reads out information on a response concerning the target brand by the subject corresponding to the designated attribute from the target brand response information storing unit 22 (S14). Next, the brand-creation process evaluation system 10 calculates six dynamic evaluation parameters from the response information to thereby acquire six dynamic evaluation parameters (S16). Then, the brand-creation process evaluation system 10 arranges the dynamic evaluation parameters in designated positions of a model format stored in the model format storing unit 20 to thereby create a brand-creation process evaluation model for the target brand (S18). The brand-creation process evaluation system 10 outputs the created brand-creation process evaluation model from the output device 14 (S20).

As explained above, according to the invention, a preferred brand-creation process evaluation model is generated and outputted. In the creation of a brand-creation process evaluation model, as shown in FIG. 2, a model format, in which arrangement of dynamic evaluation parameters determined by factor analysis is set, is prepared. Then, as shown in FIG. 8, specific dynamic evaluation parameters of a target brand are arranged in this model format.

The brand-creation process evaluation model obtained in this way accurately represents the cyclic process of knowledge creation found in brand-building. Since factor analysis is used, dynamic evaluation parameters accurately represent the state of the process and a user can easily grasp the state of the process from the dynamic evaluation parameters. When this model is used, typically, a balance among parameters in the model is examined and models are compared between competing brands. Therefore, the model serves as an extremely useful material for judgment for building a strong brand.

In the invention, as described in the embodiment, the dynamic evaluation parameters include the contact parameter, the cognition parameter, the interaction parameter, and the coherence parameter. Arrangement of these parameters is set on a cyclic path in the order described above in the model format.

In the model, “cognition” and “coherence” correspond or are equivalent to the tacit knowledge and “interaction” corresponds or is equivalent to the explicit knowledge. The model indicates importance of dynamic circulation including “cognition” and “coherence”. In particular, the model indicates importance of dynamic circulation caused by repeated occurrence of new “cognition”. That is, coherence that has undergone interaction is not a goal of brand-building. When new cognition is created from coherence through new contact, a brand is strengthened. Conversely, if there is no new cognition, the knowledge creation process is not facilitated. As a result, it may be that the growth of a brand is delayed and the brand is weakened. It is seen whether the cyclic process is functioning properly in a target brand by applying an evaluation value of the target brand to this model. Therefore, according to the invention, a material for judgment extremely useful for facilitating building of the target brand is obtained.

In the invention, the dynamic evaluation parameters further include the characterization parameter and the alignment parameter. The model format sets arrangement of the characterization parameter in association with a path from the contact parameter to the cognition parameter. In addition, the model format sets arrangement of the alignment parameter in association with a path from the interaction parameter to the coherence parameter.

In the model described above, the characterization parameter and the alignment parameter are arranged in appropriate positions of the cyclic process of brand knowledge creation. Magnitudes of these parameters indicate levels of actions that cause cognition and coherence. Since the model has these parameters, the model can represent whether process circulation is facilitated sufficiently. This model can make it easy to grasp the state of the process circulation and is extremely useful for facilitating brand-building.

The preferred embodiment of the invention has been explained. It is understood that various modifications of the embodiment are possible. It is intended that the appended claims cover all modifications falling under the true spirit and scope of the invention.

### INDUSTRIAL APPLICABILITY

The brand-creation process evaluation system of the invention can create and output dynamic evaluation information for a brand and is useful for examination of a strategy for brand-building.

1. A brand-creation process evaluation system, comprising:
model format storing means that stores information on a model format representing a cyclic process of brand knowledge creation in which arrangement of dynamic evaluation parameters, which correspond to groups of indices obtained by factor analysis of several indices for dynamic evaluation of a brand, respectively, is set;
object brand parameter acquiring means that acquires dynamic evaluation parameters for a target brand to be evaluated;
model creating means that creates a brand-creation process evaluation model of the target brand by arranging the dynamic evaluation parameters for the target brand, which are acquired by the target brand parameter acquiring means, in positions set in the model format with reference to information of the model format; and
output means that outputs information on the brand-creation process evaluation model created by the model creating means.

2. A brand-creation process evaluation system according to claim 1, wherein
the dynamic evaluation parameters include a contact parameter representing the degree of “contact” with a brand, a cognition parameter representing the degree of “cognition” being tacit knowledge with respect to the brand, an interaction parameter representing the degree of “interaction” being explicit knowledge with respect to the brand, and a coherence parameter representing the degree of “coherence” being another tacit knowledge with respect to the brand, and
arrangement of these parameters is set on a circulation path in the order described above in the model format.

3. A brand-creation process evaluation system according to claim 2, wherein
the dynamic evaluation parameters further include a characterization parameter representing “characterization”, which serves as an opportunity for shift from “contact” with a brand to “cognition” of the brand, and an alignment parameter representing “alignment” that appears when “interaction” of the brand shifts to “coherence”, and
the model format sets arrangement of the characterization parameter in association with a path from the contact parameter to the cognition parameter and sets arrangement of the alignment parameter in association with a path from the interaction parameter to the coherence parameter.

4. A brand-creation process evaluation method, comprising:
acquiring information on a model format representing a cyclic process of brand knowledge creation in which arrangement of dynamic evaluation parameters, which correspond to groups of indices obtained by factor analysis of several indices for dynamic evaluation of a brand, respectively, is set;
acquiring dynamic evaluation parameters for a target brand to be evaluated;
creating a brand-creation process evaluation model of the target brand by arranging the dynamic evaluation parameters for the target brand in positions set in the model format with reference to information of the model format; and
outputting information on the created brand-creation process evaluation model.

5. A brand-creation process evaluation method according to claim 4, wherein
the dynamic evaluation parameters include a contact parameter representing the degree of “contact” with a brand, a cognition parameter representing the degree of “cognition” being tacit knowledge with respect to the brand, an interaction parameter representing the degree of “interaction” being explicit knowledge with respect to the brand, and a coherence parameter representing the degree of “coherence” being another tacit knowledge with respect to the brand, and
arrangement of these parameters is set on a cyclic path in the order described above in the model format.

6. A brand-creation process evaluation method according to claim 5, wherein
the dynamic evaluation parameters further include a characterization parameter representing “characterization”, which serves as an opportunity for shift from “contact” with a brand to “cognition” of the brand, and an alignment parameter representing “alignment” that appears when “interaction” of the brand shifts to “coherence”, and
the model format sets arrangement of the characterization parameter in association with a path from the contact parameter to the cognition parameter and sets arrangement of the alignment parameter in association with a path from the interaction parameter to the coherence parameter.

7. A program for brand-creation process evaluation that causes a computer to execute processing for:
acquiring information on a model format representing a cyclic process of brand knowledge creation in which arrangement of dynamic evaluation parameters, which correspond to groups of indices obtained by factor analysis of several indices for dynamic evaluation of a brand, respectively, is set;
acquiring dynamic evaluation parameters for a target brand to be evaluated;
creating a brand-creation process evaluation model of the target brand by arranging the dynamic evaluation parameters for the target brand in positions set in the model format with reference to information of the model format; and
outputting information on the created brand-creation process evaluation model.

8. A program for brand-creation process evaluation according to claim 7, wherein
the dynamic evaluation parameters include a contact parameter representing a degree of “contact” with a brand, a cognition parameter representing a degree of “cognition” being tacit knowledge with respect to the brand, an interaction parameter representing a degree of “interaction” being explicit knowledge with respect to the brand, and a coherence parameter representing a degree of “coherence” being another tacit knowledge with respect to the brand, and
arrangement of these parameters is set on a cyclic path in the order described above in the model format.

9. A program for brand-creation process evaluation according to claim 8, wherein
the dynamic evaluation parameters further includes a characterization parameter representing “characterization”, which serves as an opportunity for shift from “contact” with a brand to “cognition” of the brand, and an alignment parameter representing “alignment” that appears when “interaction” of the brand shifts to “coherence”, and
the model format sets arrangement of the characterization parameter in association with a path from the contact parameter to the cognition parameter and sets arrangement of the alignment parameter in association with a path from the interaction parameter to the coherence parameter.

10. A computer readable recording medium having stored therein a program according to claim 7.

11. A brand-creation process evaluation system, comprising:
means that acquires a contact parameter representing a degree of “contact” with respect to a target brand to be evaluated;
means that acquires a cognition parameter representing a degree of “cognition” being tacit knowledge with respect to the target brand;
means that acquires an interaction parameter representing a degree of “interaction” being explicit knowledge with respect to the target brand;
means that acquires a coherence parameter representing a degree of “coherence” being another tacit knowledge with respect to the target brand;
model format storing means that stores information on a model format that sets arrangement of the contact parameter, the cognition parameter, the interaction parameter, and the coherence parameter such that the parameters are located in order on a cyclic path;
model creating means that creates a brand-creation process evaluation model of the target brand by arranging the acquired contact parameter, the acquired cognition parameter, the acquired interaction parameter, and the acquired coherence parameter in positions set in the model format with reference to information of the model format; and
output means that outputs information on the brand-creation process evaluation model created by the model creating means.

12. A brand-creation process evaluation system according to claim 11, further comprising:
means that acquires a characterization parameter representing “characterization”, which serves as an opportunity for shift from “contact” with a brand to “cognition” of the brand; and
means that acquires an alignment parameter representing “alignment” that appears when “interaction” of the brand shifts to “coherence”, wherein
the model format of the model format storing means sets arrangement of the characterization parameter in association with a path from the contact parameter to the cognition parameter and sets arrangement of the alignment parameter in association with a path from the interaction parameter to the coherence parameter, and
the model creating means arranges the acquired characterization parameter and the acquired alignment parameter in positions set in the model format.

13. A brand-creation process evaluation method, comprising:
acquiring a contact parameter representing a degree of “contact” with respect to a target brand to be evaluated;
acquiring a cognition parameter representing a degree of “cognition” being tacit knowledge with respect to the target brand;
acquiring an interaction parameter representing a degree of “interaction” being explicit knowledge with respect to the target brand;
acquiring a coherence parameter representing a degree of “coherence” being another tacit knowledge with respect to the target brand;
acquiring information on a model format that sets arrangement of the contact parameter, the cognition parameter, the interaction parameter, and the coherence parameter such that the parameters are located in order on a cyclic path;
creating a brand-creation process evaluation model of the target brand by arranging the acquired contact parameter, the acquired cognition parameter, the acquired interaction parameter, and the acquired coherence parameter in positions set in the model format with reference to information of the model format; and
outputting information on the created brand-creation process evaluation model.

14. A program for brand-creation process evaluation that causes a computer to execute processing for:
acquiring a contact parameter representing the degree of “contact” with respect to a target to be evaluated;
acquiring a cognition parameter representing a degree of “cognition” being tacit knowledge with respect to the target brand;
acquiring an interaction parameter representing a degree of “interaction” being explicit knowledge with respect to the target brand;
acquiring a coherence parameter representing a degree of “coherence” being another tacit knowledge with respect to the target brand;
acquiring information on a model format that sets arrangement of the contact parameter, the cognition parameter, the interaction parameter, and the coherence parameter such that the parameters are located in order on a cyclic path;
creating a brand-creation process evaluation model of the target brand by arranging the acquired contact parameter, the acquired cognition parameter, the acquired interaction parameter, and the acquired coherence parameter in positions set in the model format with reference to information of the model format; and
outputting information on the created brand-creation process evaluation model.
